(19) United States
(12) Patent Application Publication
(10) Pub. No.: US 2004/0044674 A1
(43) Pub. Date: Mar. 4, 2004

(54) System and method for parsing itinerary data

(76) Inventors: Said Mohammadioun, Atlanta, GA (US); Troy L. Bartlett, Dacula, GA (US); Michael M. Croom, Roswell, GA (US); David A. Wittler, Alpharetta, GA (US); Kenneth N. Haigh, Lawrenceville, GA (US); Bernard K. Henry, Alpharetta, GA (US); John W. Kish, Roswell, GA (US); David McDonald, Axworth, GA (US); William H. Jones, Atlanta, GA (US); Edward P. Bryan, Lawrenceville, GA (US); Matthew J. Mills, Cumming, GA (US); Bret A. Johnson, Alpharetta, GA (US)

Correspondence Address: SMITH, GAMBRELL & RUSSELL, LLP, 1850 M STREET, N.W., SUITE 800, WASHINGTON, DC, 20036, US

(21) Appl. No.: 10/440,403

(22) Filed: May 19, 2003

Related U.S. Application Data
(60) Provisional application No. 60/381,358, filed on May 17, 2002.

(51) Int. Cl. G06F 17/00

(52) U.S. Cl. 707/100

(57) ABSTRACT

The present invention provides a system and method for parsing itinerary data on a computing device. In architecture, the system includes a data acquisition module that acquires itinerary data and a parsing module that parses the itinerary data into the a computer readable itinerary data. The system further includes a generation module that generates a predefined user form with the computer readable itinerary data. The present invention can also be viewed as a method for parsing itinerary data on a computing device. The method operates by (1) providing itinerary data; (2) parsing the itinerary data into a computer readable itinerary data; and (3) generating a predefined user form with the computer readable itinerary data.

### CROSS-REFERENCE TO RELATED APPLICATIONS

This application claims the benefit of U.S. Provisional Application Serial No. 60/381,358, filed on May 17, 2002, entitled “E-mail Itinerary Parsing” which is incorporated by reference herein in its entirety.

### FIELD OF THE INVENTION

The present invention relates to a method and system for parsing data and files, and more particularly, relates to a method and system for parsing emails or itinerary data.

### BACKGROUND OF THE INVENTION

On-line travel systems have become popular in the recent years. The software for the travel systems provides user access to airline, hotel, car rental and other travel agencies databases through screens on their computer systems. Some of the best-known online travel systems include airline reservation systems, Expedia and Orbitz, to name just a few. Travel systems are most often accessed utilizing the Internet, since the general public is becoming more computer sophisticated.

However, because there are so many travel services that can be accessed and reserved on line, there is a problem with associating all this data in a convenient form. Many times users simply print a separate itinerary, e-mail or other notice for each different reservation acquired. Others may make notes in a Day-Timer® notebook or other calendar book or in some type of software such as Microsoft Outlook® or in their Palm handheld device. Still, all this data must be manually processed which leads to human error and fatigue.

Thus, heretofore an unaddressed need exists in the industry to address the aforementioned deficiencies in associating travel data in a convenient form quickly and efficiently.

### SUMMARY OF THE INVENTION

The invention provides a system and method for parsing itinerary data. The invention may be conceptualized as a parsing system on a computing device, such as a server or client system. In architecture, the system includes a data acquisition module that acquires itinerary data and a parsing module that parses the itinerary data into the a computer readable itinerary data. The system further includes a generation module that generates a predefined user form with the computer readable itinerary data.

The present invention can also be viewed as a method for parsing itinerary data on a computing device. The invention may also be conceptualized as a method for parsing itinerary data on a computing device, such as a server or client system. The method comprising the steps of: (1) providing itinerary data; (2) parsing the itinerary data into a computer readable itinerary data; and (3) generating a predefined user form with the computer readable itinerary data.

### BRIEF DESCRIPTION OF THE DRAWINGS

The present invention, as defined in the claims, can be better understood with reference to the following drawings. The components within the drawings are not necessarily to scale relative to each other, the emphasis instead being placed upon clearly illustrating the principles of the present invention.

FIG. 1 is a block diagram illustrating an example of the network environment for a server and the client computer systems utilizing the parsing system of the present invention.

FIG. 2 is a block diagram illustrating an example of a computer system device utilizing the parsing system of the present invention, as shown in FIG. 1.

FIG. 3 is a flow chart illustrating an example of the process flow of the e-mail system on computer devices that utilize the parsing system of the present invention, as shown in FIGS. 1 and 2.

FIG. 4 is a flow chart illustrating an example of the operation of the parsing system of the present invention utilized by the computer device, as shown in FIGS. 1-3.

FIG. 5 is a flow chart illustrating an example of the operation of the validation process that is utilized in the parsing system of the present invention, as shown in FIGS. 2-4.

FIG. 6 is a flow chart illustrating an example of the operation of the source type process that is utilized in the parsing system of the present invention, as shown in FIGS. 2-4.

FIG. 7 is a flow chart illustrating an example of the operation of the parse process that is utilized in parsing system of the present invention, as shown in FIGS. 2-4.

FIG. 8 is a flow chart illustrating an example of the operation of the update process that is utilized in the parsing system of the present invention, as shown in FIGS. 2-4.

### DETAILED DESCRIPTION OF THE INVENTION

The invention to be described hereafter is applicable to all computer systems using a parsing system of the present invention to create and update itinerary data on a computer device. While described below with respect to a single computer, the system and method for parsing itinerary data can be implemented in a networked computing arrangement in which a number of computing devices communicate over a local area network (LAN), over a wide area network (WAN), or over a combination of both LAN and WAN.

The parsing system of the present invention accomplishes two primary goals: (1) Keeps vital travel data consolidated for a user's personal computing devices and a server; and (2) Delivers updated travel data to users that is particularly relevant while mobile.

Mobile professionals will carry multiple mobile computing devices, all of which have specific usage and connection characteristics, making each device uniquely appropriate for certain mobile usage situations. Given this diversity of devices, an obvious user problem is the organization of information, including but not limited to travel information, of these remote devices. The parsing system of the present invention provides universal translation and organization of a user's travel information, parsed from their email, and organized via their calendar. However, the parsing system of the present invention can be utilized for parsing other kinds of information and organizing it via contact, calendar, to do items, memos and personalized information data on computer devices. For example, the parsing system of the present invention will support:

Office PC (Outlook, other personal information managers (PIMs), etc.)

Home PC (Outlook, +other PIMs, etc.)

Palm OS devices (native PIM apps, etc.)

Win CE OS devices (Pocket Outlook, etc.)

Web browser (full PIM info, etc.)

WAP-based phones (full PIM info, etc.)

Non-WAP phones (SMS support, etc.)

The parsing system of the present invention also parses relevant mobile information on user's devices. These broad guidelines serve to illustrate the type of information delivered:

Information defined by particular travel arrangements the user has;

Information defined by particular appointments the user has;

Information defined by particular trips the user has;

Information defined by particular contacts the user has;

Information defined by particular companies of contacts the user has;

Information defined by particular financial information of company contacts the user has;

Information defined by particular competitive information the user has;

Information defined by particular financial and sales information for competitors that the user has;

Information defined by particular product information for the competitors that the user has;

General information that the user needs whenever, wherever they are.

Travel-based information, working in conjunction with the parsing system of the present invention, provides the intelligent delivery of mobile information. In the preferred embodiment, the user can specify the automatic parsing of particular types of data including but not limited to travel information. An alternative embodiment, the user can specify which documents or data sources are to be parsed.

Through wizard-type interfaces, a user can specify certain relevant documents or data sources to be processed by the parsing system of the present invention. This user specified sources are in addition to or replacement of the system predefined data sources, Based on this information, the parsing system of the present invention can assemble and process important relevant data from a variety of content providers and deliver it to the user's computer devices. For example, if a user is making a trip to Seattle, beginning a few weeks in advance of the trip, the user's remote device can be delivered information about the weather, flight information, directions, hotel information, car rental information, taxi, by user selection, as a prescheduled function and/or a device received request. When this information is received on the user's remote device, it can be parsed into a coherent document for the user.

Before and during a trip, travel information can be added/removed/updated on the user's mobile devices. Likewise, based on appointments in a calendar, users can receive directions, company information, etc. that is useful in successfully conducting that appointment. All content is intelligently delivered to a user's different mobile devices based on the device capabilities and different user configuration settings. Information like financial, sales, stock ticker information, product and competitive company information can be configured to be parsed and organized to a user's mobile devices. Alert conditions can be set to monitor relevant items like flight status, traffic news, weather updates, stock prices, appointment information, daily trip information, etc.

The parsing system of the present invention can be, but is not limited to, a tiered architecture (i.e. separate tiers for client, business logic services, and data storage), which provides scalability as well as multiple ways of interacting with the data in the central database. The application can reside on a single computer, or on a cluster of computers for scalability and reliability. These computers can be either servers or client devices, or a combination of both. Each computer device either runs the parsing system itself or organizes its local data store with a central data store that contains the output of the parsing system.

Itinerary data can be piped in from 3^{rd} party vendors, stored in the central database and formatted by the parsing system of the present invention. Content for a particular user is available directly, such as on a Web site, and is also parsed and downloaded to the user's devices for offline viewing.

To provide the parsing and organization, software is installed on each user's device. This software serves to translate and map the travel information to the specific format of the specific user device. The client/server communication during the parsing and organization session can be performed, for example but not limited to, via HTTP to eliminate firewall issues. The parsing system of the present invention may also support HTTPS (SSL), for users that parsed and organized via their ISP or other non-secure connections to the Internet.

The parsing system of the present invention includes a data store, such as a central database 12. This data store is can be scalable and access to the data store can be performed via a set of data access APIs, which serve to decouple the parsing system components and services from the database. This architecture enhances scalability and robustness by controlling and pooling database access, and gives the flexibility to port the data store to other platforms without making modifications to core components or services. This data store can be a relational database, such as but not limited to Microsoft SQL Server. Alternatively, it can be the same data store used to store server-side email and PIM information, such as but not limited to Microsoft Exchange and Lotus Domino. It could also be the same data store used to store client-side email and PIM information, such as but not limited to Microsoft Outlook or Pocket PC Pocket Outlook.

The output of the parsing system can be presented to the user in various ways. It can be presented via the user's PIM application(s). For example, the parsing system can create an out-of-office calendar entry corresponding to each trip that the user is taking, based on the user's parsed itineraries. The parsing system can also create separate calendar entries for each flight on which the user is booked. These calendar entries can be output to all the user's devices. The output can also be presented via user interface (UI), such as but not limited to HTML pages, that contain all the user's travel information formatted in a consistent, user-friendly manner. This formatted information can be presented on a Web site or to a user's devices. The output can be presented via a WAP (Wireless Application Protocol) site, allowing the user to access his travel information via most cell phones, which are WAP capable. The output can also be presented via alert messages—messages sent at appropriate times to email-addressable wireless phones and pagers or other devices. These alert messages can contain flight reminders, the day's travel itinerary, or other information extracted by the parsing system.

The WAP and Web Services also connect to the central data store, allowing users to work directly against the data stored in the central data store. Changes made to the data in the data store while a user is connected will be queued and sent. All data sent to the remote devices and can be initiated on a user action, via a predetermined scheduled update and/or by requested of the user. The wireless application protocol (WAP) services work for users with WAP browsers in their wireless handsets. The parsing system does not provide the WAP gateway; this is provided by the user's wireless carrier.

An alerting engine monitors user travel data, and when an alert condition is met, an alert is queued and sent to the user. Alerts may also be sent by the data store to the user's remote device in order to initiate a download of travel data. Currently, the parsing system provides alerts for parsing the data and download requests, as well as other types of data. Alerts can be sent as email messages via an SMTP server, which can be formatted as Short Message Service (SMS) messages. This enables parsing system to send alerts to email-addressable wireless phones and pagers, in addition to standard email clients.

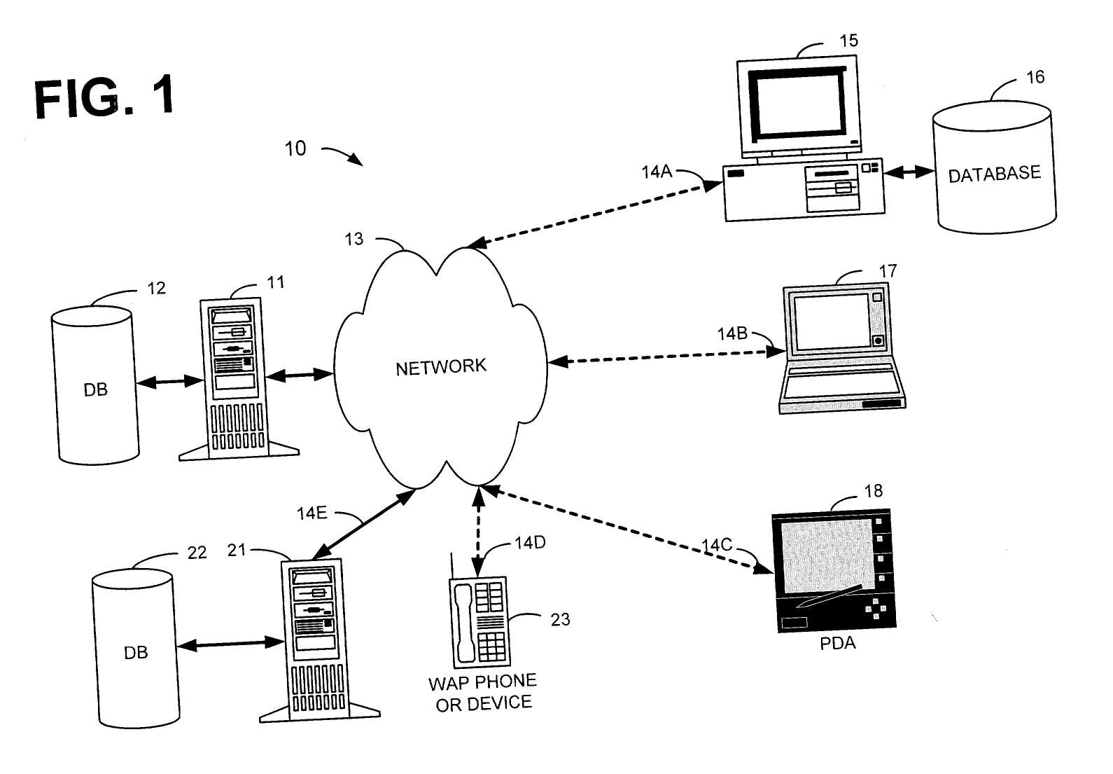

Referring now to the drawings, in which like numerals illustrate like elements throughout the several views, FIG. 1 illustrates the basic components of a system 10 using the parsing system used in connection with the preferred embodiment of the present invention. The system 10 includes remote client systems 15, 17, 18 and 23. Each client has applications and can have a local data store 16. Computer servers 11 and 21 contain applications and server 11 further contains a server database 12 that is accessed by client systems 15, 17, 18 and 23 via intermittent connections 14(a-d), respectively, over network 13. The server 11 runs administrative software for a computer network and controls access to part or all of the network and its devices. The client systems 15, 17, 18 and 23 share the server data stored on the database 12 and may access the server 11 over a network 13, such as but not limited to: the Internet, a local area network (LAN), a wide area network (WAN), via a telephone line using a modem or other like networks. The server 11 may also be connected to client systems 15, 17, 18 and 23 through any combination of networks including but not limited to those described within this document. The server 11 may also be connected to the local area network (LAN) within an organization.

The structure and operation of the system 10 enables the server 11 and the database 12 associated therewith to handle clients more efficiently than previously known systems. Particularly, the parsing system of the present invention provides a manner of organizing travel data on the computer device. Periodically, as a predetermined documents or data sources are processed these documents or data sources can data identified for parsing to extract predetermined types of information.

The client systems 15, 17, 18 and 23 may each be located at remote sites. Client systems 15, 17, 18 and 23 include but are not limited to, PCs, workstations, laptops, Palm and Pocket PC, PDAs, pagers, Web browser devices, WAP devices, cell phones and the like. Thus, when a user at one of the remote client systems 15, 17, 18 and 23 desires to acquire current travel information, the client system 15, 17, 18 and 23 communicates over the network 13, such as but not limited to WAN, internet, or telephone lines to access the server 11. Server 11 can then either provide the parsed travel information or provide raw data to the remote client system 15, 17, 18 or 23 said that the remote system may parse the desired travel information.

Third party vendors' computer systems 21 and databases 22, running a mail server or other application, can be accessed by the server 11 or the remote client system 15, 17, 18 or 23 in order to obtain updated travel information for dissemination to the remote devices. Data that is obtained from third party vendors computer system 21 and database 22 can be stored on the server 11 or database 12 in order to provide later access to the user remote devices 15, 17, 18 and 23. It is also contemplated that for certain types of data that the remote user devices 15, 17, 18 and 23 can access the third party vendors data directly using the network 13.

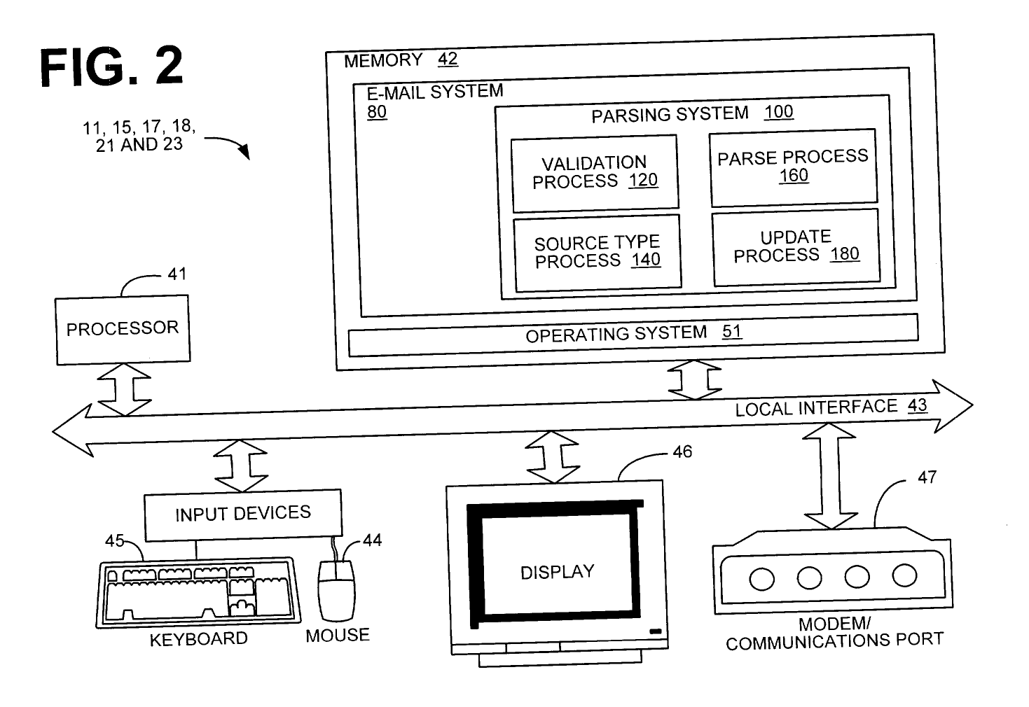

Illustrated in FIG. 2 is a block diagram demonstrating an example of a computer system device utilizing the parsing system 100 of the present invention, as shown in FIG. 1. The computer system device may represent server 11 or remote devices 15, 17, 18 and 23. Remote devices 15, 17, 18 and 23 include, but are not limited to, PCs, workstations, laptops, PDAs, pagers, WAP devices, non-WAP devices, cell phones, palm devices and the like. The components of the remote device 15, 17, 18 and 23 are substantially similar to that of the description for the server 11 (FIG. 1). However, it is contemplated that many of the components in the user's remote device 15, 17, 18 and 23 can be more limited in general function.

Generally, in terms of hardware architecture, as shown in FIG. 2, the computer devices 11, 15, 17, 18, 21 and 23 (herein is include a processor 41, memory 42, and one or more input and/or output (I/O) devices (or peripherals) that are communicatively coupled via a local interface 43. The local interface 43 can be, for example but not limited to, one or more buses or other wired or wireless connections, as is known in the art. The local interface 43 may have additional elements, which are omitted for simplicity, such as controllers, buffers (caches), drivers, repeaters, and receivers, to enable communications. Further, the local interface 43 may include address, control, and/or data connections to enable appropriate communications among the aforementioned components.

The processor 41 is a hardware device for executing software that can be stored in memory 42. The processor 41 can be virtually any custom made or commercially available processor, a central processing unit (CPU) or an auxiliary processor among several processors associated with the computer 11, 15, 17, 18, 21 and 23, and a semiconductor based microprocessor (in the form of a microchip) or a macroprocessor. Examples of suitable commercially available microprocessors are as follows: an 80x86 or Pentium series microprocessor from Intel Corporation, U.S.A., a PowerPC microprocessor from IBM, U.S.A., a Sparc microprocessor from Sun Microsystems, Inc, a PA-RISC series microprocessor from Hewlett-Packard Company, U.S.A., or a 68xxx series microprocessor from Motorola Corporation, U.S.A.

The memory 42 can include any one or combination of volatile memory elements (e.g., random access memory (RAM, such as dynamic random access memory (DRAM), static random access memory (SRAM), etc.)) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 42 may incorporate electronic, magnetic, optical, and/or other types of storage media. Note that the memory 42 can have a distributed architecture, where various components are situated remote from one another, but can be accessed by the processor 41.

The software in memory 42 may include one or more separate programs, each of which comprises an ordered listing of executable instructions for implementing logical functions. In the example illustrated in FIG. 2, the software in the memory 42 includes a suitable operating system (O/S) 51 and the parsing system 100 of the present invention. Also included is e-mail system 80.

A non-exhaustive list of examples of suitable commercially available operating systems 51 is as follows: a Windows operating system from Microsoft Corporation, U.S.A., a Netware operating system available from Novell, Inc., U.S.A., an operating system available from IBM, Inc., U.S.A., any LINUX operating system available from many vendors or a UNIX operating system, which is available for purchase from many vendors, such as Hewlett-Packard Company, U.S.A., Sun Microsystems, Inc. and AT&T Corporation, U.S.A. The operating system 51 essentially controls the execution of other computer programs, such as the parsing system 100, and provides scheduling, input-output control, file and data management, memory management, and communication control and related services. However, it is understood by the inventors that the parsing system 100 of the present invention is applicable on all other commercially available operating systems.

The parsing system 100 may be a source program, executable program (object code), script, or any other entity comprising a set of instructions to be performed. When a source program, then the program is usually translated via a compiler, assembler, interpreter, or the like, which may or may not be included within the memory 42, so as to operate properly in connection with the O/S 51. Furthermore, the parsing system 100 can be written as (a) an object oriented programming language, which has classes of data and methods, or (b) a procedure programming language, which has routines, subroutines, and/or functions, for example but not limited to, C, C++, Pascal, BASIC, FORTRAN, COBOL, Perl, Java,, ADA and the like.

The I/O devices may include input devices, for example but not limited to, a keyboard 45, mouse 44, scanner (not shown), microphone (not shown), etc.

Furthermore, the I/O devices may also include output devices, for example but not limited to, a printer (not shown), display 46, etc. Finally, the I/O devices may further include devices that communicate both inputs and outputs, for instance but not limited to, a NIC or modulator/demodulator 47 (for accessing other files, devices, systems, or a network), a radio frequency (RF) or other transceiver (not shown), a telephonic interface (not shown), a bridge (not shown), a router (not shown), etc.

If the computers 11, 15, 17, 18, 21 and 23 are a PC, workstation, intelligent device or the like, the software in the memory 42 may further include a basic input output system (BIOS) (omitted for simplicity). The BIOS is a set of essential software routines that initialize and test hardware at startup, start the O/S 51, and support the transfer of data among the hardware devices. The BIOS is stored in some type of read-only-memory, such as ROM, PROM, EPROM EEPROM or the like, so that the BIOS can be executed when the computer 11, 15, 16, 18 21 and 23 is activated.

When the computers 11, 15, 16, 18, 21 and 23 are in operation, the processor 41 is generally configured to execute software stored within the memory 42, to communicate data to and from the memory 42, and to generally control operations of the computer 11, 15, 16, 18 21 and 23 pursuant to the software. The parsing system 100 and the O/S 51 are read, in whole or in part, by the processor 41, perhaps buffered within the processor 41, and then executed.

When the parsing system 100 is implemented in software, as is shown in FIG. 2, it should be noted that the parsing system 100 can be stored on virtually any computer readable medium for use by or in connection with any computer related system or method. In the context of this document, a computer readable medium is an electronic, magnetic, optical, or other physical device or means that can contain or store a computer program for use by or in connection with a computer related system or method. The parsing system 100 of the present invention can be embodied in any computer-readable medium for use by or in connection with an instruction execution system, apparatus, or device, such as a computer-based system, processor-containing system, or other system that can fetch the instructions from the instruction execution system, apparatus, or device and execute the instructions.

In the context of this document, a “computer-readable medium” can be any means that can store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

In an alternative embodiment, where the parsing system 100 is implemented in hardware, the parsing system 100 can be implemented with any one or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

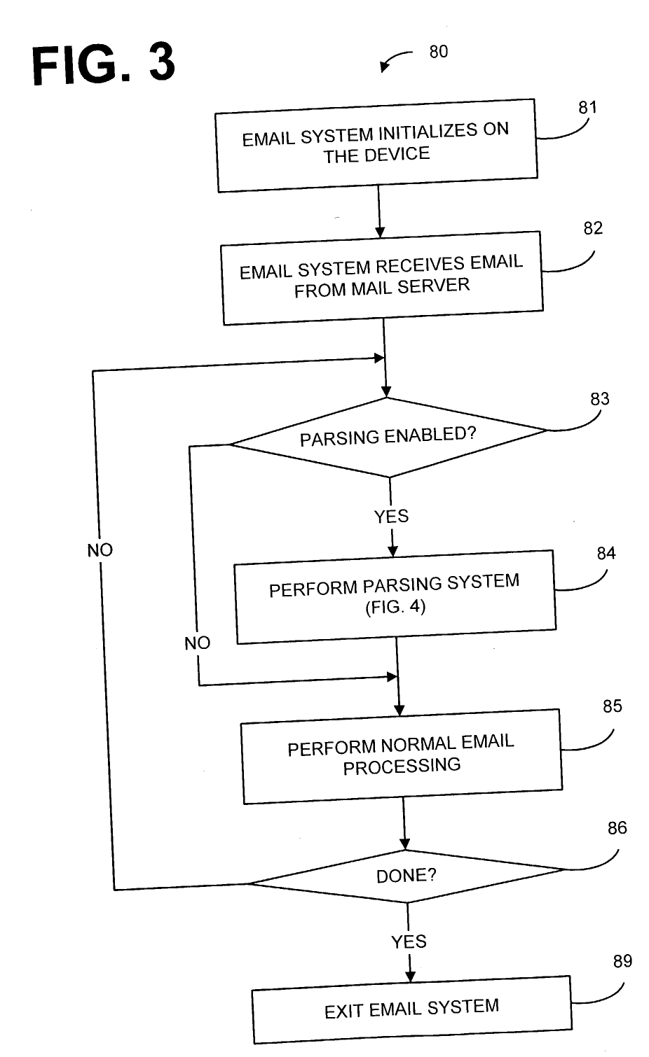

Illustrated in FIG. 3 is a flow chart demonstrating an example of the process flow of the e-mail system 80 on computer devices 11, 15, 16, 18, 21 or 23 that utilizes the parsing system 100 of the present invention, as shown in FIGS. 1 and 2. For the sake of simplicity, computer devices 11, 15, 16, 18, 21 or 23 are here after referred to as computer device 25. E-mail system 80 is used as an example to illustrate the parsing system 100 of the present invention. In this example, e-mails received via the e-mail system 80 can be parsed for specified types of information. These types of information include, but are not limited to travel, contact, financial, competitor, company, product, meeting notification, sales confirmation and the like.

First at step 81, the e-mail system 80 is the initialized on computer device 25. This initialization includes the startup routines and process embedded in the BIOS of the computer device 25. The initialization also includes the establishment of data values for any data structures utilized on computer device 25. At step 82, the e-mail system 80 receives e-mail from a mail server (not shown). In an alternative embodiment, a potential itinerary may be received by fetching it from a Web site.

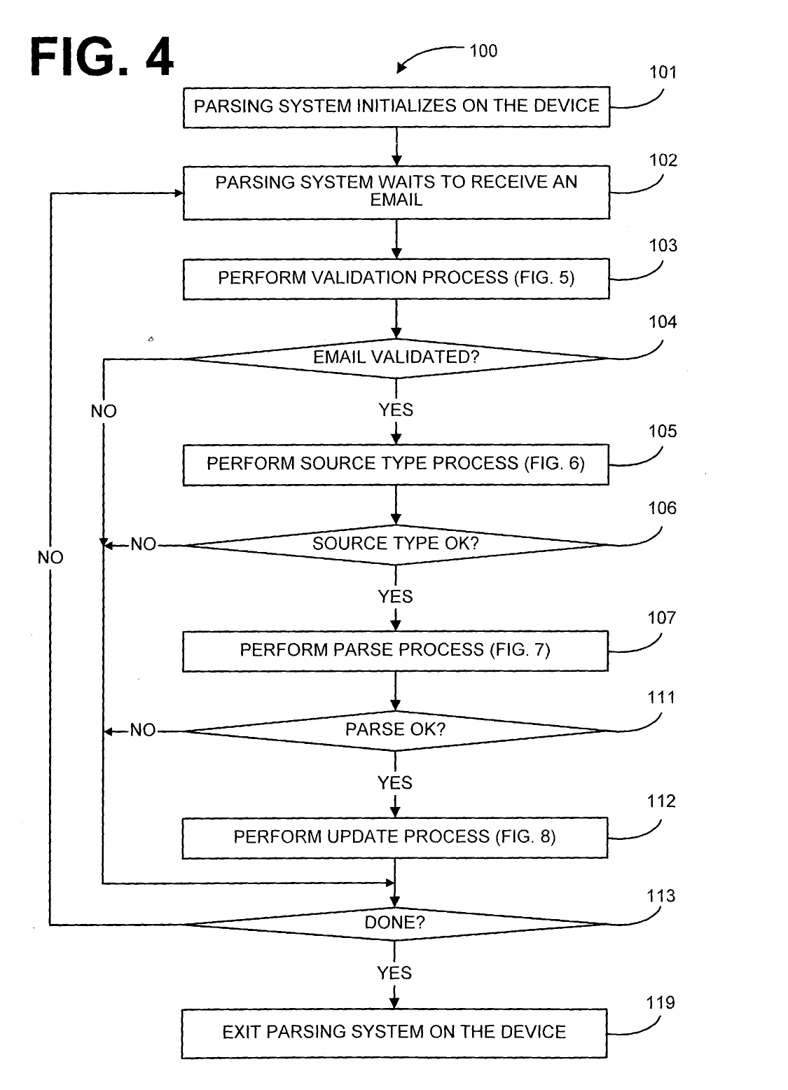

At step 83, it is determined if the e-mail received on the computer device 25 is to be parsed. If it is determined at step 83 that the e-mail received is not to be parsed, the e-mail system 80 then jumps to step 85. However, if it is determined at step 83 that parsing is enabled for e-mails, the e-mail system 80 then performs the parsing system 100 at step 84. The parsing system 100 is herein defined for the detail with regard to FIG. 4.

At step 85, the e-mail system 80 then performs normal e-mail processing. At step 86, it is determined to the user desires to continue normal operation of the computer device 25. If it is determined that the user wishes to continue normal operation of the e-mail system 80, then the e-mail system 80 returns to repeat steps 82 through 86. However, it is determined at step 86 that the user wishes to terminate operation of the e-mail system 80, then the e-mail system 80 then exits at step 89.

Illustrated in FIG. 4 is a flow chart demonstrating an example of the operation of the parsing system 100 of the present invention utilized by the computer device 25, as shown in FIGS. 1-3. The parsing system 100 of the present invention enables a user to identify particular types of data to be parsed, including but not limited to travel, contact, financial, competitor, company, product information, meeting notification, sales confirmation and the like. An alternative embodiment, the user can specify what should be parsed, by using some UI to select a particular email, Web page, document, section of text, or other information to be parsed.

First, the parsing system 100 is initialized at step 101, and performs similar functions as the initialization of the e-mail process 80 for computer device 25 as described above. The initialization also includes the establishment of data values for particular data structures utilized in the parsing system 100. Next at step 102, the parsing system 100 waits to receive an input data source to be parsed. In this example, the parsing system 100 waits for an e-mail document. In the preferred embodiment the parsing system 100 parses travel information. However, it should be understood that the user may define which types of data sources are to be parsed and for what types of information.

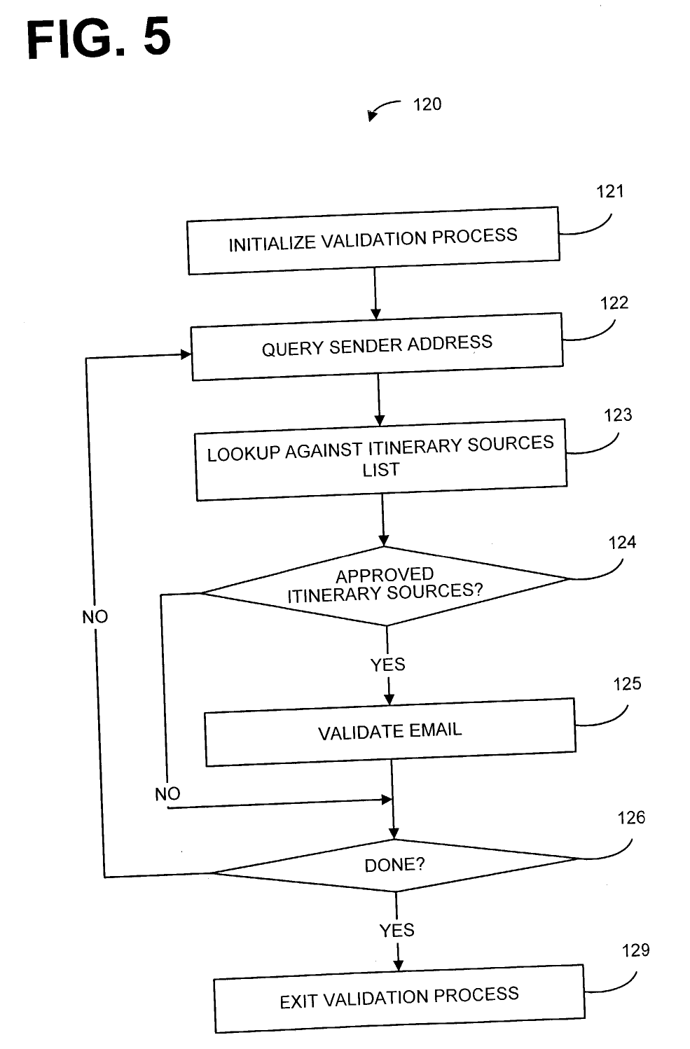

After receiving an e-mail at step 102, the parsing system 100 performs the validation process at step 103. The validation process is herein defined in further detail with regard to FIG. 5. The validation process is performed in order to determine if the e-mail received is from an approved itinerary source. In the preferred embodiment, validation process allows only itineraries from approved corporate travel agencies to be processed. Additionally, validation process is a performance optimization (i.e. only emails where the sender address is a known itinerary provider need be processed). It should be understood that the validation process is optional; some users may choose that all emails should pass the validation step and attempt to be parsed.

It should be understood that the type of data to be parsed (i.e. source data) may be compared against many types of source lists for information types to be parsed. In alternative embodiments, these types of source lists for information types can be created for other types of data, such as, but not limited to: inbox, outbox, sent items, drafts, calendars, contacts, to do, other note type information files, application data, application software and personalized information. After the validation process is performed at step 103, the parsing system 100 determines if the e-mail passed the validation step.

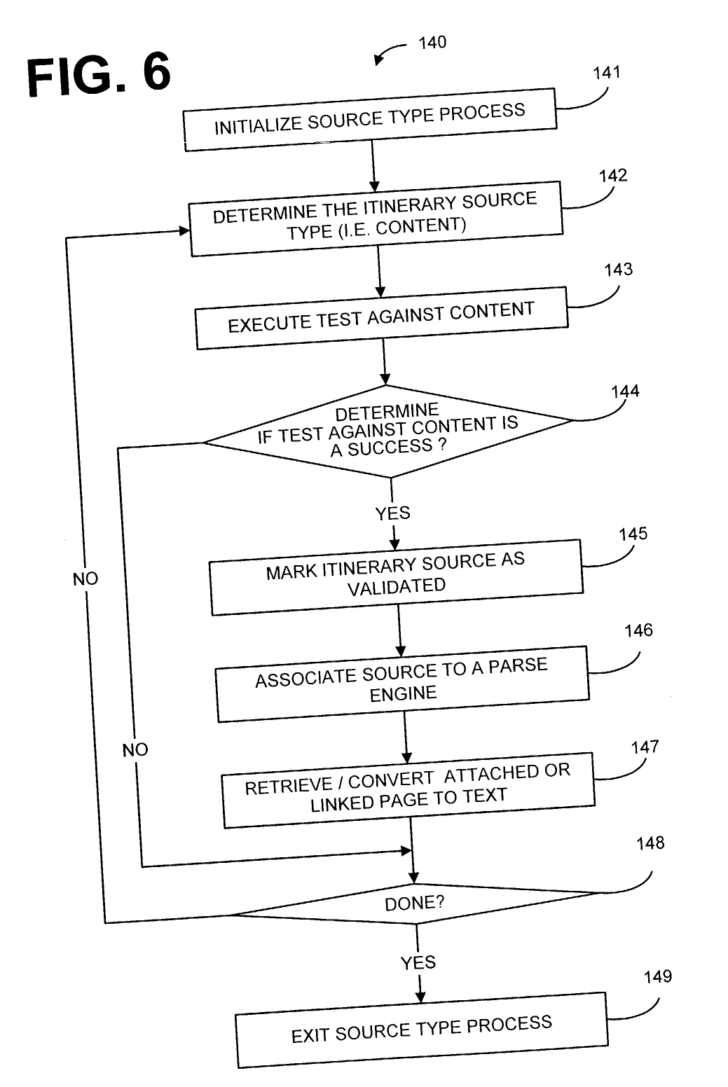

If it is determined to step 104 that the e-mail did not to pass the validation step, then the parsing system 100 proceeds to step 113. However, if it is determined at step 104 that the e-mail did passed the validation step, then the parsing system 100 performs the source type process at step 105. The source type process is herein defined in further detail with regard to FIG. 6. The source type process determines if the information type (i.e. source type) can be determined. In the example described herein, the source type process determines if the e-mail contains itinerary data, and, if it does, the itinerary's source (the travel system that constructed the itinerary information in the email). By knowing the itinerary source, parsing code specific to the itinerary source's format can be invoked in the parse process, 160. After the source type process is performed at step 105, the parsing system 100 determines if the e-mail passed the source type process step.

If it is determined to step 106 that the e-mail did not to pass the source type process step, then the parsing system 100 proceeds to step 113. However, if it is determined at step 106 that the e-mail did pass the source type process step then the parsing system 100 performs the parsing process at step 107. The parsing process performed at step 107, actually transforms the source content into a user predefined form and format. The user can select the output form and format for the parsed source content. The form and format can be data items such as travel, contact, financial, competitor, company, product information and the like. After the parsed process is performed at step 107, the parsing system 100 then determines if the e-mail was parsed successfully at step 111.

If it is determined to step 111 that the e-mail did not to pass the parsed process step, then the parsing system 100 proceeds to step 113. However, if it is determined at step 111 that the e-mail did pass the parsed process step then the parsing system 100 performs the update process at step 112. The update process performed at step 112, updates the related information which includes, but is not limited to the following types of related data: inbox, outbox, sent items, drafts, calendars, contacts, to do, other note type information files, application data, application software and personalized information. The types of personalized information include, but are not limited to, weather type information, travel information, contact information, contact activity information, and contact company information. Contact company information can include competitive information such as competitive company information, competitive activity of a company, news, financial and company products and as well as other products of interest.

After the update process is performed at step 112, the parsing system 100 then determines if there are more e-mails to be processed. If it is determined to step 113 that there are no more e-mails to be processed, then the parsing system 100 exits at step 119. However, if it is determined at step 113 that there are more e-mails to be processed, then the parsing system 100 returns to repeat steps 102 through 113.

Illustrated in FIG. 5 is a flow chart demonstrating an example of the operation of the validation process 120 that is utilized in the parsing system 100 of the present invention, as shown in FIGS. 2-4. The validation process 120 is performed in order to determine if the e-mail received is from an approved itinerary source. It should be understood that the type of data to be parsed (i.e. source data) may be compared against many types of source lists for information types to be parsed.

The validation process 120 enables a user to select the desired itinerary sources that are accepted as valid. In the example described herein, the valid sources are described by listing acceptable sender email addresses. Email address can be specified by providing a full email address (i.e., “sender@orbitz.com”) or just a portion of an email address (i.e. “orbitz.com”). The user or a system administrator can override these accepted itinerary sources. A number of different methods can be utilized to enable the user to perform the selections. One example technique is to utilize dialog box or UI to indicate which types of itinerary sources are acceptable.

First, the validation process 120 is initialized at step 121, and performs similar functions as the initialization of the e-mail process 80 on computer device 25 as described above. The initialization also includes the establishment of data values for particular data structures utilized in the validation process 120. At step 122, the validation process 120 executes query against the senders address. At step 123 the validation process 120 performs a look up of the senders address against the list of accepted itinerary sources.

At step 124, the validation process 120 determines if the e-mail is from an approved itinerary source. If it is determined to step 124 that the e-mail is not from an approved source, the validation process 120 then skips to step 126. However, it is determined to step 124 that the e-mail is from an approved itinerary source within the validation process 120 then marks the e-mail as valid.

At step 126, the validation process 120 determines if there are more e-mails to be validated. If it is determined at step 126 that there are more e-mails to be validated, and the validation process 120 returns to repeat steps 122 through 126. However, it is determined at step 126 that there are no more e-mails to be validated, then the validation process 120 then exits at step 129.

Illustrated in FIG. 6 is a flow chart demonstrating an example of the operation of the source type process 140 that is utilized in the parsing system 100 of the present invention, as shown in FIGS. 2-4. The source type process 140 determines if the information type (i.e. source type) can be established. The example described herein is with regard to the application to e-mail itinerary data. However, it is understood that different type of information can be parsed using the parsing system 100 of the present invention.

In the illustrated example, the source type process 140 determines if the type of information which is in the e-mail it contains itinerary data, and, if it is, what the source/format of the itinerary might be. One way to determine the itinerary source is to look for certain keywords particular to the itinerary source. It is understood however, that other types of data, not just emailed itineraries as illustrated in this example, may be defined as an appropriate source type. Other types of data may include but are not limited to the following types: emailed meeting notifications, emailed contact information, itineraries on Web pages, and so forth.

First, at step 141, the source type process 140 is initialized, and performs similar functions as the initialization of the e-mail process 80 as described above. The initialization also includes the establishment of data values for particular data structures utilized in the source type process 140. At step 142, the source type process 140 determines the itinerary source type (i.e. the type of the contents of the e-mail). It is understood that other types of data can be configured instead of the illustrated example of utilizing itinerary information. At step 143, the source type process 140 executes a test against the contents of the e-mail.

At step 144, the source type process 140 determines if a test against the contents was a success. If it is determined to step 124 that the test against the contents was not a success, the source type process 140 then skips to step 148. However, if it is determined at step 144 that the test against the contents was a success then the source type process 140 marks the itinerary source as validated at step 145. At step 146, the source type process 140 associates the source to a parse engine. At step 147, the source type process 140 retrieves any attached file or linked Web page and convert it to plain text, which will be provided as input to the parse process 160.

At step 148, the source type process 140 determines if there are more itinerary source types to be processed. If it is determined at step 148 that there are more itinerary source types to be processed, then the source type process 140 returns to repeat steps 142 through 148. However, if it is determined at step 148 that there are no more itinerary source types to be processed, then the source type process 140 exits at step 149.

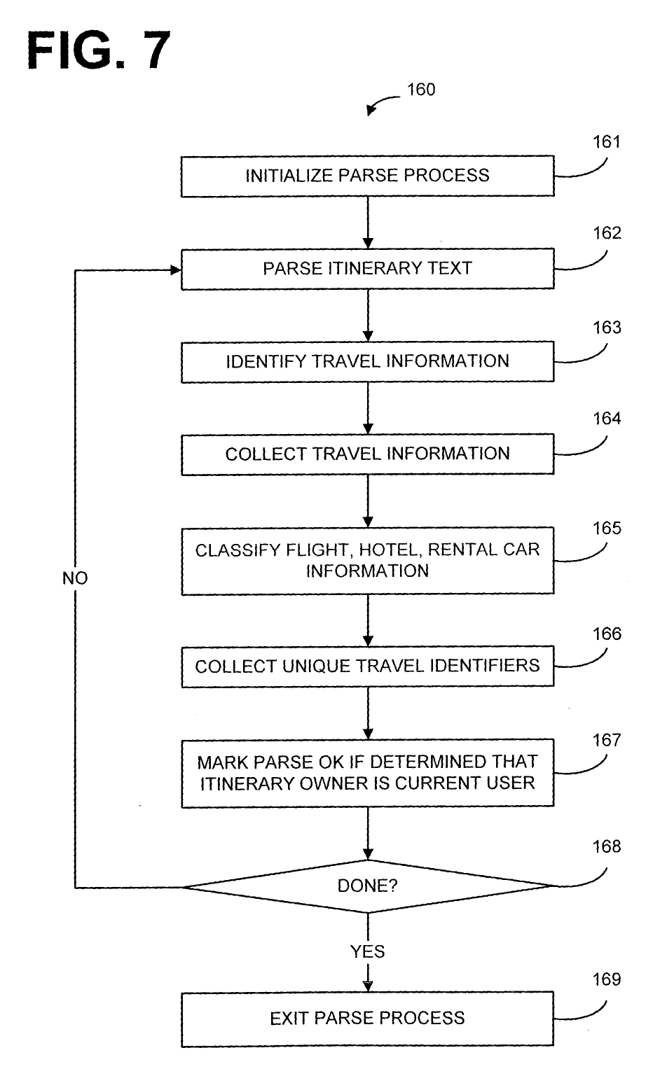

Illustrated in FIG. 7 is a flow chart demonstrating an example of the operation of the parse process 160 that is utilized in parsing system 100 of the present invention, as shown in FIGS. 2-4. In the illustrated example operation of the parse process 160, the itinerary data within e-mails it is utilized. However, it is understood that other types of information may be captured and translated from other source types. For example, calendar information may be extracted from PDF documents, Word documents, web pages and the like.

The parsing process 160 actually transforms or extracts the source content from a data source for placement into a user predefined form and format. The user can select the form and format for the source content into which should be e-mail is to be the parsed. The form and format can be defined as data items such as travel, contact, financial, competitor, company, product information and the like.

First, the parse process 160 is initialized at step 161, and performs similar functions as the initialization of the e-mail process 80, as described above. The initialization also includes the establishment of data values for particular data structures utilized in the parse process 160. At step 162, the parse process 160 parses the itinerary text in the e-mail.

At step 163, the parse process 160 identifies the travel information and collects the travel information at step 164. At step 165, the parse process 160 classifies the itinerary information including, but not limited to, flights, hotel reservations, rental car information, and the like. At step 166, the parse process 160 collects any unique travel identifiers for the itinerary, such as for example, but not limited to a travel system reservation number.

Next, the parse process 160 marks the parse operation as successful if it determines that the itinerary owner it is the current user. By only importing itineraries for the current user, the parsing system 100 of the present invention ensures that itineraries for other travelers, contained in forwarded emails, are ignored. At step 168, the parse process 160 determines if there are more itinerary texts to be parsed. If it is determined to step 168 that there are more itineraries to be parsed then the parse process 160 returns to repeat steps 162 through 168. However, if it is determined at step 168 that there are no more itineraries to be parsed, then the parse process 160 then the exits at step 169.

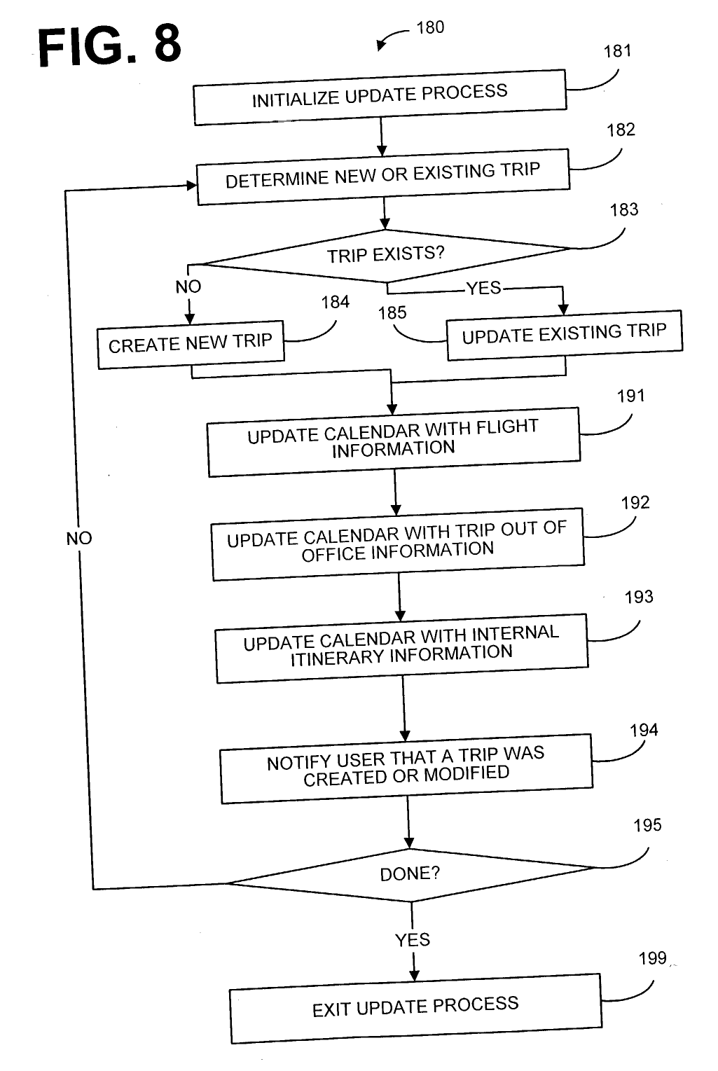

Illustrated in FIG. 8 is a flow chart demonstrating an example of the operation of the update process 180 that is utilized in the parse system 100 of the present invention, as shown in FIGS. 2-4. The update process updates the related information which includes, but is not limited to the following types of related data: inbox, outbox, sent items, drafts, calendars, contacts, to do, other note type information files, application data, application software and personalized information. The types of personalized information include, but are not limited to, travel information, weather type information (potentially based on the travel destinations extracted from an itinerary), contact information, contact activity information, and contact company information. Contact company information can include competitive information such as competitive company information, competitive activity of a company, news, financial and company products and as well as other products of interest.

First, the update process 180 is initialized at step 181, and performs similar functions as the initialization of the e-mail process 80, as described above. The initialization also includes the establishment of data values for particular data structures utilized in the update process 180. At steps 182 and 183, the update process 180 determines if the parsed itinerary information relates to a new or a previously existing trip. This determination is made based on the unique travel identifiers collected in 166. In the case where the user books travel then subsequently makes changes to their itinerary, they can get multiple emails for the same itinerary, in which case it's best to update existing trip information rather than create a new trip. If it is determined that the parsed information is for a new trip, then the update process 180 creates a new trip document at step 184. However, it is determined at step 183 that the information relates to an existing trip, then the update process 180 acquires and updates the existing trip document at step 185.

At step 191, the update process 180 updates the user's calendar with flight information. It also updates, at step 192, the calendar to indicate that the user is out of the office for the duration of the trip. At step 193, the update process 180 then updates the calendar with internal itinerary information. This internal information contains all the known data pertaining to the trip and can be used by other presentation mechanisms to display the itinerary. For example, a set of Web pages describing all the users upcoming trips could be constructed from this information.

At step 194, the user is notified that a trip was created or modify. This notification can be accomplished in many different ways, which include but are not limited to the creation of a separate e-mails sent to the users e-mail account, including a notice at the bottom of the trip document, generating a line item in the users calendar, or the like. In the preferred embodiment, some text is inserted at the top of the emailed itinerary, indicating that the itinerary was imported. At step 195, the update process 180 then determines if there are more trips to be processed. If it is determined at step 185 that there are more trips to be processed then, the update process 180 returns to repeat steps 182 through 195. However, it is determined at step 195 that there are no more trips to be processed, then the update process 180 then exits at step 199.

It will be apparent to those skilled in the art that many modifications and variations may be made to embodiments of the present invention, as set forth above, without departing substantially from the principles of the present invention. All such modifications and variations are intended to be included herein within the scope of the present invention, as defined in the claims that follow.

What is claimed is:

1. A method for parsing itinerary data on a computing device, comprising the steps of:
providing itinerary data;
parsing the itinerary data into a computer readable itinerary data; and
generating a predefined user form with the computer readable itinerary data.

2. The method of claim 1, further comprises the step of:
determining a source type of the itinerary data.

3. The method of claim 1, wherein the parsing itinerary data step further comprises:
extracting predetermined types of data to generate the computer readable form, wherein the predetermined types of data is selected from the group consisting of appointment data, itinerary data, calendar data, flight data, hotel data, taxi data, rental car data and contact data.

4. The method of claim 1, wherein the generating the predefined user form step further comprises:
determining if the predefined user form for the itinerary data already exists; and
updating with the itinerary data if the predefined user form already exists.

5. The method of claim 4, further comprising the step of:
updating related information wherein the related information is selected from the group consisting of inbox, outbox, sent items, drafts, calendars, contacts, to do, other note type information files, application data, application software and personalized information.

6. The method of claim 1, wherein the itinerary data is electronic mail data.

7. A method for parsing electronic mail data on a computing device, comprising the steps of:
acquiring electronic mail data;
parsing the electronic mail data for a predefined data type; and
generating a predefined user form with predefined data type data.

8. A parsing system that parses itinerary data on a computing device, comprising:
a data acquisition module that acquires itinerary data;
a parsing module that parses the itinerary data into the a computer readable itinerary data; and
a generation module that generates a predefined user form with the computer readable itinerary data.

9. The system of claim 8, wherein the parsing system further comprises:
a source determination module that determines a source type of the itinerary data.

10. The system of claim 8, wherein the parsing module further comprises:
extracting module that extracts predetermined types of data from the itinerary data to generate the computer readable form.

11. The system of claim 8, wherein the generation module further comprises:
a form discovery module that determines if the predefined user form for the itinerary data already exists; and
a form update module that updates the predefined user form with the itinerary data if the predefined user form the already exists.

12. The system of claim 8, wherein the generation module further comprises:
a related info module for updating related information wherein the related information is selected from the group consisting of inbox, outbox, sent items, drafts, calendars, contacts, to do, other note type information files, application data, application software and personalized information.

13. The system of claim 8, wherein the itinerary data is electronic mail data.

14. A parsing system that parses electronic mail data on a computing device, comprising:
a data acquisition module that acquires electronic mail data;
a parsing module that parses the electronic mail data into the a computer readable email data; and
a generation module that generates a predefined user form with the computer readable email data.

15. A computer readable medium for a parsing system that parses itinerary data on a computing device, comprising:
logic for acquiring itinerary data;
logic for parsing the itinerary data into a computer readable itinerary data; and
logic for generating a predefined user form with the computer readable itinerary data.

16. The computer readable medium of claim 15, wherein the logic for parsing further comprises:
logic for determining a source type of the itinerary data.

17. The computer readable medium of claim 15, wherein the logic for parsing further comprises:
logic for extracting predetermined types of data to generate the computer readable form, wherein the predetermined types of data is selected from the group consisting of appointment data, itinerary data, calendar data, flight data, hotel data, taxi data, rental car data and contact data.

18. The computer readable medium of claim 15, wherein the logic for generating further comprises:
logic for determining if the predefined user form for the itinerary data already exists; and
logic for updating with the itinerary data if the predefined user form already exists.

19. The computer readable medium of claim 15, wherein the logic for generating further comprises:
logic for updating related information wherein the related information is selected from the group consisting of inbox, outbox, sent items, drafts, calendars, contacts, to do, other note type information files, application data, application software and personalized information.

20. The computer readable medium of claim 15, wherein the itinerary data is electronic mail data.

21. A computer readable medium for a parsing system that parses electronic mail data on a computing device, comprising:
logic for acquiring electronic mail data;
logic for parsing the electronic mail data for a predefined data type; and
logic for generating a predefined user form with predefined data type data.

22. A system for parsing itinerary data on a computing device, comprising:
means for providing itinerary data;
means for parsing the itinerary data into a computer readable itinerary data; and
means for generating a predefined user form with the computer readable itinerary data.

23. The system of claim 22, further comprising:
means for determining a source type of the itinerary data.

24. The system of claim 22, further comprising:
means for extracting predetermined types of data to generate the computer readable form, wherein the predetermined types of data is selected from the group consisting of appointment data, itinerary data, calendar data, flight data, hotel data, taxi data, rental car data and contact data.

25. The system of claim 22, further comprising:
means for determining if the predefined user form for the itinerary data already exists; and
means for updating with the itinerary data if the predefined user form already exists.

26. The system of claim 22, further comprising:
means for updating related information wherein the related information is selected from the group consisting of inbox, outbox, sent items, drafts, calendars, contacts, to do, other note type information files, application data, application software and personalized information.

27. The system of claim 22, wherein the itinerary data is electronic mail data.

28. A system for parsing electronic mail data on a computing device, comprising:
means for acquiring electronic mail data;
means for parsing the electronic mail data for a predefined data type; and
means for generating a predefined user form with predefined data type data.
